(19) United States
(12) Patent Application Publication
(10) Pub. No.: US 2013/0218598 A1
(43) Pub. Date: Aug. 22, 2013

(54) ELECTRONIC MEDICAL CODING SYSTEMS

(71) Applicant: MEDICOMP SYSTEMS, INC., (US)

(72) Inventors: Jamey K. Aita, Arlington, VA (US); Roy Soltoff, Sterling, VA (US); Levis R. Karl, Vienna, VA (US)

(73) Assignee: MEDICOMP SYSTEMS, INC., Chantilly, VA (US)

(21) Appl. No.: 13/773,520

(22) Filed: Feb. 21, 2013

Related U.S. Application Data
(60) Provisional application No. 61/601,432, filed on Feb. 21, 2012.

(51) Int. Cl. G06F 19/00; G06Q 50/24

(52) U.S. Cl. CPC G06F 19/322; G06Q 50/24
USPC 705/3

(57) ABSTRACT

Systems and methods for coding an aspect of a patient encounter. An example method includes: receiving a medical finding identifying medical information related to a patient, the medical finding being input by a user; identifying an internal medical code of an internal medical terminology that relates to the medical finding; retrieving one or more alternative data items from an expansion table associated with the internal medical code, the alternative data items defining the medical finding input by the user with great specificity; generating a graphical user interface, the graphical user interface displaying the medical finding input by the user and the one or more alternative data items, the displayed one or more alternative data items being selectable by the user; and in response to selecting one of the one or more alternative data items, selecting a code from the standard medical terminology that identifies the medical finding in the standard medical terminology based on the categorical information.

### REFERENCE TO CO-PENDING APPLICATIONS

This application claims the benefit of priority of U.S. Provisional Application No. 61/601,432, filed Feb. 21, 2012, and entitled, “ELECTRONIC MEDICAL CODING SYSTEMS,” the disclosure of which is incorporated by reference herein in its entirety.

### BACKGROUND

Many different medical coding standards exist for documenting medical information. Most standards rely on their own unique medical terminologies. In addition, each standard can require collection of different information from the caregiver. There is a need for improved techniques for collecting the appropriate information from the caregiver to be able to identify the appropriate codes.

### SUMMARY

In general terms, this disclosure is directed to an electronic medical coding system.

In one embodiment, a method of coding an aspect of a patient encounter performed by an electronic computing system is presented. The method includes: receiving, at a processing unit, a medical finding identifying medical information related to a patient, the medical finding being input by a user; identifying, by the processing unit, an internal medical code of an internal medical terminology that relates to the medical finding; retrieving from memory, by the processing unit, one or more alternative data items from an expansion table associated with the internal medical code, the alternative data items defining the medical finding input by the user with great specificity; generating a graphical user interface, the graphical user interface displaying the medical finding input by the user and the one or more alternative data items, the displayed one or more alternative data items being selectable by the user; and in response to selecting one of the one or more alternative data items, selecting a code from the standard medical terminology that identifies the medical finding in the standard medical terminology based on the categorical information.

In another embodiment, a system is discussed. The system includes: a database encoded on a memory device, the data comprising a first terminology and a second terminology; the first terminology including a first set of terms identifying medical information, wherein each term of the first set of terms is associated with a first medical code; the second terminology including a second set of terms, wherein each term of the second set of terms is associated with a second medical code. The system further includes a computing device in data communication with the database, wherein the computing device is programmed to retrieve data from the first terminology and map the data to a second medical code.

### BRIEF DESCRIPTION OF THE DRAWINGS

FIG. 1 illustrates an exemplary embodiment of an electronic healthcare system.

FIG. 2 illustrates an exemplary architecture of a computing device that can be used to implement aspects of the present disclosure.

FIG. 3 illustrates an exemplary architecture of an application program of the computing device of FIG. 2 and a database of the electronic healthcare system.

FIG. 4 illustrates an exemplary embodiment of a mapping of internal medical terminology to an internal diagnostic relationship data.

FIG. 5 illustrates an exemplary embodiment of a data structure of internal-to-external relationship data.

FIG. 6 is a flowchart illustrating an exemplary embodiment of a method of mapping user inputs associated with an internal code to an external code through a medical information coding system.

FIG. 7 is a diagram illustrating exemplary operations of the method of FIG. 6.

FIG. 8 is an exemplary screen shot during use of the medical information coding system of FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments.

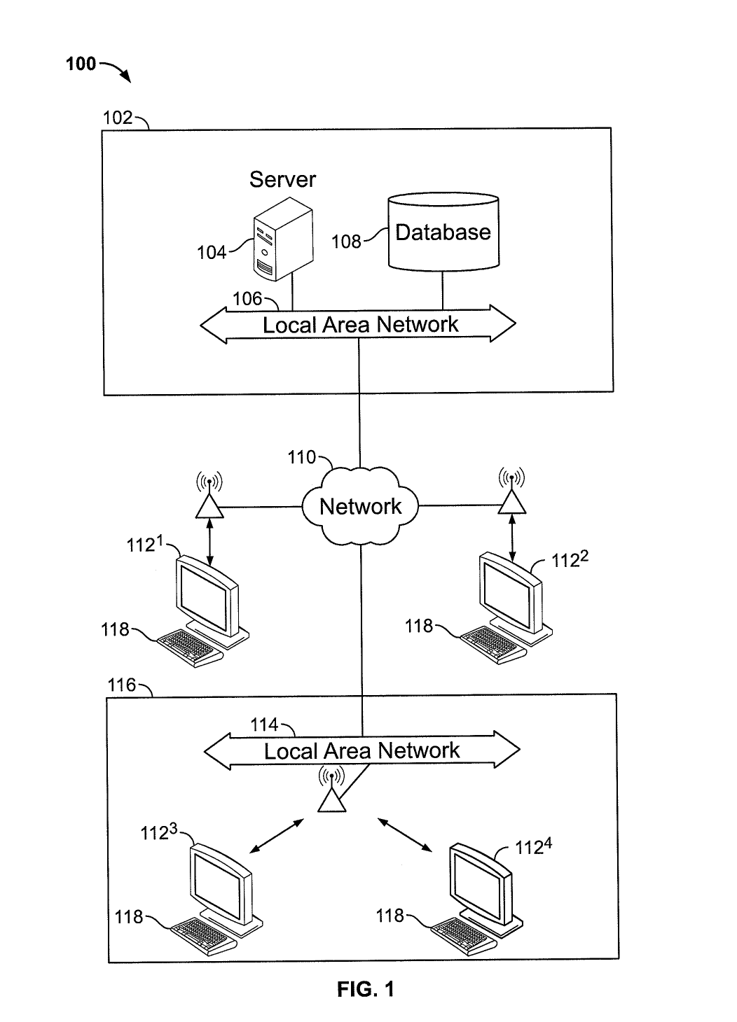

FIG. 1 illustrates an exemplary embodiment of an electronic healthcare system 100. Caregivers interact with the electronic healthcare system 100 to access medical information and/or to document patient encounters. The system 100 includes a medical information coding system 102, a network 110, and user computing devices 112. User computing devices 112 include stand-alone computing devices 112¹ and 112² as well as networked computing devices 112³ and 112⁴ that are connected to local area network 114.

Some embodiments of medical information coding system 102 include a server 104 and a database 108 that communicate across local area network 106. The database 108 includes various external and internal medical terminologies, and operates to store medical information relating to medical conditions and to send selected portions of the medical information across network 110 when requested by a computing device 112. The medical information coding system 102 can be located at the same location (such as in the same room, building, or facility) as one or more of the computing devices 112. Alternatively, the medical information coding system 102 is located remotely from the computing devices 112, such as in a different building, city, state, country, or continent.

The server 104 controls access to information stored in the medical information coding system 102, in some embodiments. In one example embodiment, the server 104 is a computing device that includes a database software application, such as the SQL SERVER® database software distributed by MICROSOFT® Corporation. In other possible embodiments, the server 104 is a Web server or a file server. When a request for medical information is received by the server 104, the server retrieves the medical information from the database 108 and sends it across the network 110 to the computing device 112 that requested it.

The database 108 is a data storage device configured to store a variety of medical information. Examples of a possible database 108 include a hard disk drive, a collection of hard disk drives, digital memory (such as random access memory), a redundant array of independent disks (RAID), or other data storage devices. In some embodiments, medical information is distributed across multiple local or remote data storage devices. The database 108 stores data or data items in an organized manner, such as in a hierarchical or relational database structure, or in lists and other data structures such as tables. Although the database 108 is illustrated as being separated from the computing devices 112 by the network 110, the database 108 is alternatively a local data storage device of a computing device 112 or is connected to the same local area network 114 as the computing device 112.

The network 110 communicates digital data between one or more computing devices, such as between the medical information coding system 102 and the computing devices 112. Examples of the network 110 include a local area network and a wide area network, such as the Internet.

In some embodiments, the network 110 includes a wireless communication system, a wired communication system, or a combination of wireless and wired communication systems. A wired communication system can transmit data using electrical or optical signals in various possible embodiments. Wireless communication systems typically transmit signals via electromagnetic waves, such as in the form of radio frequency (RF) signals. A wireless communication system typically includes a RF transmitter for transmitting radio frequency signals, and an RF receiver for receiving radio frequency signals. Examples of wireless communication systems include Wi-Fi communication devices (such as utilizing wireless routers or wireless access points), cellular communication devices (such as utilizing one or more cellular base stations), and other wireless communication devices.

In some example embodiments, computing devices 112 are computing devices used by a caregiver that display a caregiver interface 118. Caregivers include physicians, psychiatrists, counselors, therapists, medical assistants, secretaries, receptionists, or other people that are involved in providing care to a patient and/or documenting clinical visits with a patient. In some embodiments, a computing device 112 is located at a point of care, such as within a room where a caregiver and a patient interact. In other embodiments, a computing device 112 is located near the point of care, such as in a hallway or nearby room. However, in other possible embodiments the computing device 112 is not located near the point of care.

In some embodiments, computing devices are mobile computing devices, such as a tablet computer (such as the iPad® device available from Apple, Inc.), a smartphone, or other mobile computing devices. In some embodiments, computing devices 112 include a touch sensitive display for receiving input from a user.

In one example embodiment, the electronic healthcare system 100 includes stand-alone computing devices 112¹ and 112², as well as networked computing devices 112³ and 112⁴. Stand-alone computing devices 112¹ and 112² connect directly to network 110 and are not part of an additional local area network. In some embodiments, the stand-alone computing devices connect through a wireless network, such as a cellular telephone network. Networked computing devices 112³ and 112⁴ are connected to a local area network 114 which may be within a facility 116, such as a hospital, clinic, office, or other building. In some embodiments, a connection to the local area network is made wirelessly through a wireless access point connected to the local area network. More or fewer computing devices 112 are included in other possible embodiments and can be located in one or more facilities or locations.

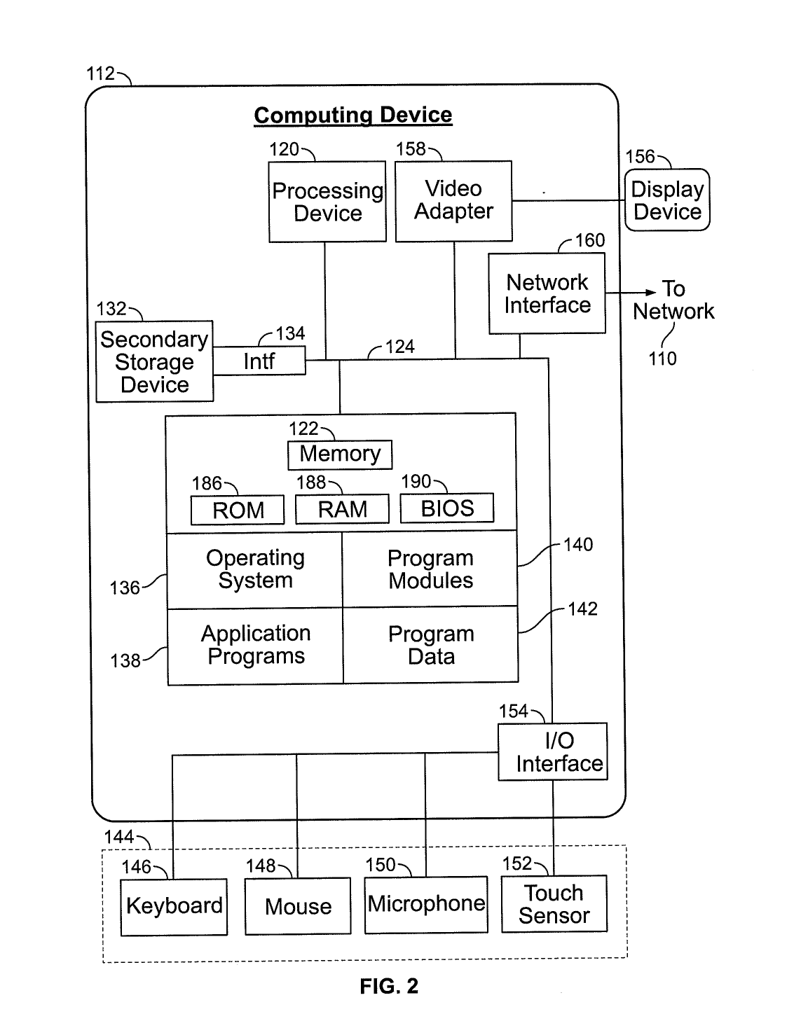

FIG. 2 illustrates an exemplary architecture of a computing device that can be used to implement aspects of the present disclosure, including the server 104 or the computing device 112. One or more computing devices, such as the type illustrated in FIG. 2, are used to execute the operating system, application programs, and software modules (including the software engines) described herein.

The computing device 112 includes, in some embodiments, at least one processing device 120, such as a central processing unit (CPU). A variety of processing devices are available from a variety of manufacturers, for example, Intel or Advanced Micro Devices. In this example, the computing device 112 also includes a system memory 122, and a system bus 124 that couples various system components including the system memory 122 to the processing device 120. The system bus 124 is one of any number of types of bus structures including a memory bus, or memory controller; a peripheral bus; and a local bus using any of a variety of bus architectures.

Examples of computing devices suitable for the computing device 112 include a desktop computer, a laptop computer, a tablet computer, a mobile phone device such as a smart phone, or other devices configured to process digital instructions.

The system memory 122 includes read only memory 126 and random access memory 128. A basic input/output system 130 containing the basic routines that act to transfer information within computing device 112, such as during start up, is typically stored in the read only memory 126.

The computing device 112 also includes a secondary storage device 132 in some embodiments, such as a hard disk drive, for storing digital data. The secondary storage device 132 is connected to the system bus 124 by a secondary storage interface 134. The secondary storage devices and their associated computer readable media provide nonvolatile storage of computer readable instructions (including application programs and program modules), data structures, and other data for the computing device 112.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 132 or memory 122, including an operating system 136, one or more application programs 138, other program modules 140, and program data 142. The database 108 may be stored at any location in the memory 122, such as the program data 142, or at the secondary storage device 132.

In some embodiments, computing device 112 includes input devices to enable the caregiver to provide inputs to the computing device 112. Examples of input devices 144 include a keyboard 146, pointer input device 148, microphone 150, and touch sensitive display 152. Other embodiments include other input devices 144. The input devices are often connected to the processing device 120 through an input/output interface 154 that is coupled to the system bus 124. These input devices 144 can be connected by any number of input/output interfaces, such as a parallel port, serial port, game port, or a universal serial bus. Wireless communication between input devices and interface 154 is possible as well, and includes infrared, BLUETOOTH® wireless technology, 802.11a/b/g/n, cellular, or other radio frequency communication systems in some possible embodiments.

In this example embodiment, a touch sensitive display device 156 is also connected to the system bus 124 via an interface, such as a video adapter 158. The touch sensitive display device 156 includes touch sensors for receiving input from a user when the user touches the display. Such sensors can be capacitive sensors, pressure sensors, or other touch sensors. The sensors not only detect contact with the display, but also the location of the contact and movement of the contact over time. For example, a user can move a finger or stylus across the screen to provide written inputs. The written inputs are evaluated and, in some embodiments, converted into text inputs.

In addition to the display device 156, the computing device 112 can include various other peripheral devices (not shown), such as speakers or a printer.

When used in a local area networking environment or a wide area networking environment (such as the Internet), the computing device 112 is typically connected to the network through a network interface, such as a wireless network interface 160. Other possible embodiments use other communication devices. For example, some embodiments of the computing device 112 include an Ethernet network interface, or a modem for communicating across the network.

The computing device 112 typically includes at least some form of computer-readable media. Computer readable media includes any available media that can be accessed by the computing device 112. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 112.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

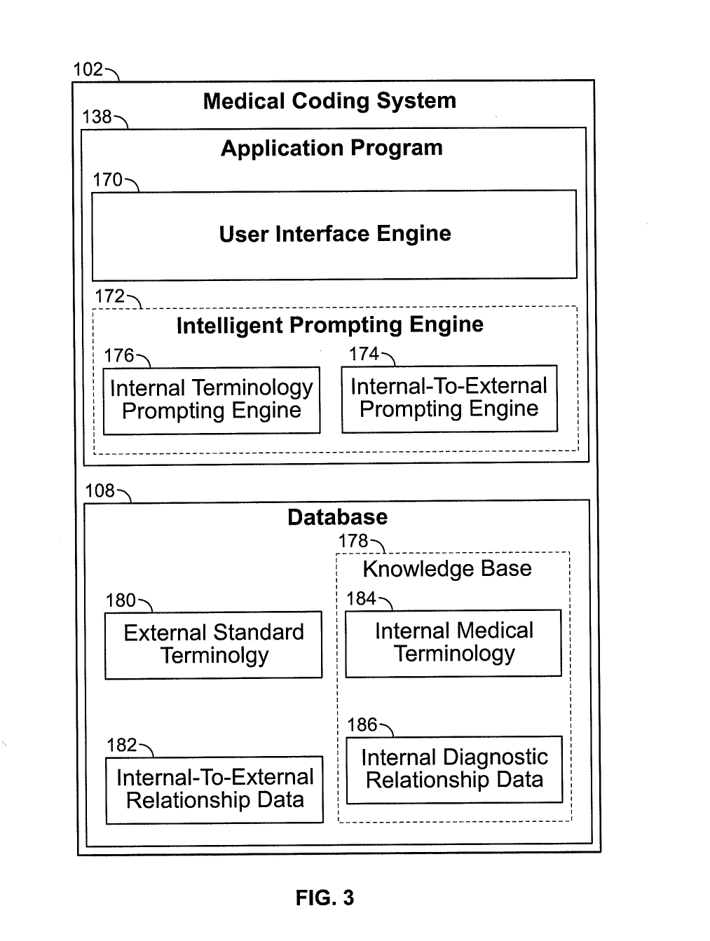

FIG. 3 illustrates exemplary aspects of the electronic healthcare system 100. As one example embodiment, an application program 138 operates on the computing device 112. In other embodiments, however, the application program 138 operates on one or more other computing devices, such as server 104. In this example, the medical coding system 102 includes a plurality of engines that, when executed by the processor, perform one or more operations of the application program 138. The engines include a user interface engine 170 and an intelligent prompting engine 172. The intelligent prompting engine 172 includes an internal terminology prompting engine 176 and an internal-to-external prompting engine 174. In other embodiments, the plurality of engines could be stored at any other location in the memory 122, such as the program modules 140 (shown in FIG. 2).

The database 108 is stored in one or more data storage devices, such as the memory 122 or the secondary storage device 132 (shown in FIG. 2) of the computing device 112 or another server computing device. The database 108 can alternatively be part of the computing device 112, or selected data or data items can be retrieved from database 108 and stored locally on the computing device 112. The database 108 includes a knowledge base 178, an external standard terminology 180, and an internal-to-external relationship data 182. The knowledge base 178 includes an internal medical terminology 184 and an internal diagnostic relationship data 186.

The user interface engine 170 receives inputs from a caregiver through the input/output interface 154. Examples of such inputs include inputs from a keyboard 146, a pointer input device 148, a microphone 150, or touch sensitive display 152. In some embodiments, touch inputs are received from a caregiver through the touch sensitive display device 156. Examples of inputs from a caregiver include descriptions and/or names of medical conditions and health problems, findings, symptoms, and/or answers to questions presented to the user through the input/output interface 154 by the intelligent prompting engine 172.

In general, the intelligent prompting engine 172 functions in two main ways. First, the intelligent prompting engine 172 utilizes the internal terminology prompting engine 176 to prompt the caregiver with a list of findings related to an inputted medical condition, or alternatively, prompt the caregiver with a list of medical conditions related to a list of inputted symptoms. For example, if a caregiver inputs “bacterial pneumonia” into the system 102, the user interface engine 170 processes the input, and the internal terminology prompting engine 176 may present a listing of symptoms associated with bacterial pneumonia, including “coughing,” “wheezing,” “chest congestion,” etc. Alternatively, the caregiver may input “coughing,” “wheezing,”, and/or “chest congestion,” and the internal terminology prompting engine 176 may present a listing of medical conditions associated with the symptoms. Upon receiving the prompted list, the caregiver may select the appropriate symptoms or medical conditions that appear to be relevant for the patient.

It is understood that a caregiver input may be any medical information. Medical information can be any medical item, such as, for example, a symptom, medical history, an examination finding, a diagnosis, a test, a physical characteristic, a mental characteristic, a therapy, and the like. The medical information may be information gathered during the course of a patient/caregiver interaction or general medical information not related to a particular patient. In some embodiments disclosed herein, findings are stored as data items in one or more data records.

The system 102 utilizes the knowledge base 178 to present the appropriate listing of findings and/or medical conditions to the caregiver. For example, the internal medical terminology 184 may include a list of symptoms, medical conditions, and internal medical codes for each, utilized internally by the computing device 112. Furthermore, the internal diagnostic relationship data 186 may include data structures such as tables and/or lists which internally connect the various medical conditions, associated symptoms, and associated internal medical codes. In some embodiments, for example, all of the information or a substantial part of the information stored in the internal medical terminology 184 and the internal diagnostic relationship data 186 is relevant to medical diagnoses. Examples of how the system 102 intelligently prompts the caregiver based on the knowledge base 178 are shown in the issued patent entitled, INTELLIGENT PROMPTING, U.S. Pat. No. 5,823,949, issued on Oct. 20, 1998, by Peter S. Goltra, the entire disclosure of which is incorporated by reference herein.

Secondly, the intelligent prompting engine 172, utilizes the internal-to-external prompting engine 174 to prompt the user with a variety of questions so that the system 102 can map the selected symptoms and/or medical conditions from the internal medical terminology 184 (discussed above) to the associated symptoms, medical conditions, or descriptions in the external standard terminology 180. For example, in some embodiments, the internal-to-external prompting engine 174 utilizes the internal-to-external relationship data 182 to determine the relationships between selected symptoms and/or medical conditions in the internal medical terminology 184 to the external standard terminology 180. In some embodiments, the external standard terminology 180 includes data that is informational, but not diagnostically relevant, for example, information relevant to billing.

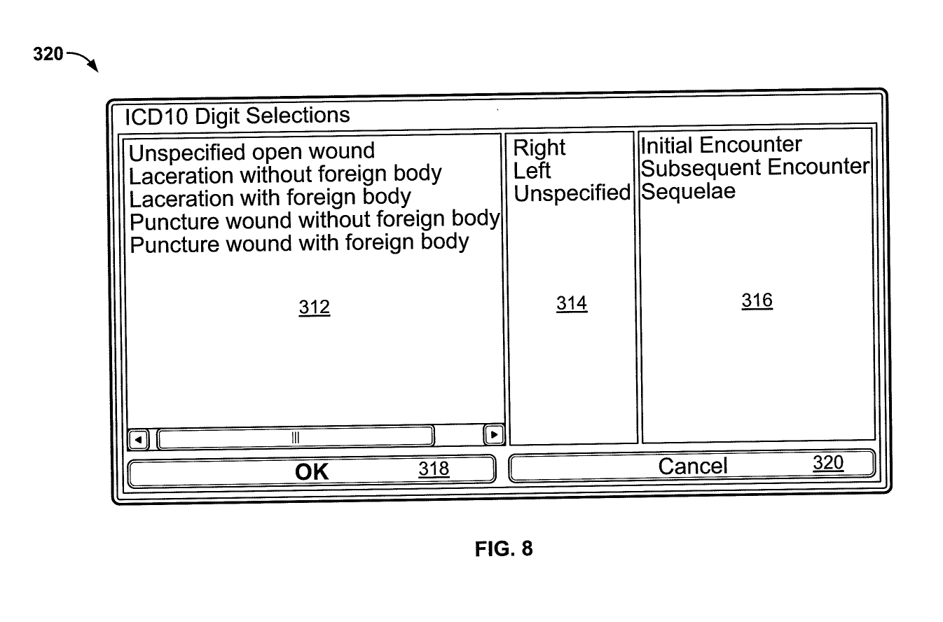

The external standard terminology 180 is stored in the database 108. In some embodiments, the external standard terminology 180 includes a list of descriptions, such as, symptoms, medical conditions, and/or medical conditions in conjunction with terms that are not diagnostically relevant, with associated external medical codes for each item. The internal-to-external relationship data 182 includes various data structures, such as tables, hierarchical structures, or the like, to store information relating the internal medical terminology 184 to the external standard terminology 180. In some embodiments, each data structure in the internal-to-external relationship data 182 indicates to the internal-to-external prompting engine 174 that more information is needed from the caregiver to accomplish the mapping. At such time, the internal-to-external prompting engine 174 prompts the caregiver with a query, such as an open-ended question, multiple choice question, or an option to select items (as shown in FIG. 8).

An example of the external standard terminology 180 is the International Statistical Classification of Diseases and Related Health Problems (ICD), such as the ICD-10-CM (10^{th} revision), which was scheduled for use in the United States beginning on Oct. 1, 2013, although implementation has been recently put on indefinite hold. Future revisions are also examples of the external standard terminology. Other embodiments utilize other standard medical terminologies, such as one or more of the RxNORM standard, the Logical Observation Identifiers Names and Codes (LOINC) standard, and other medical terminology standards.

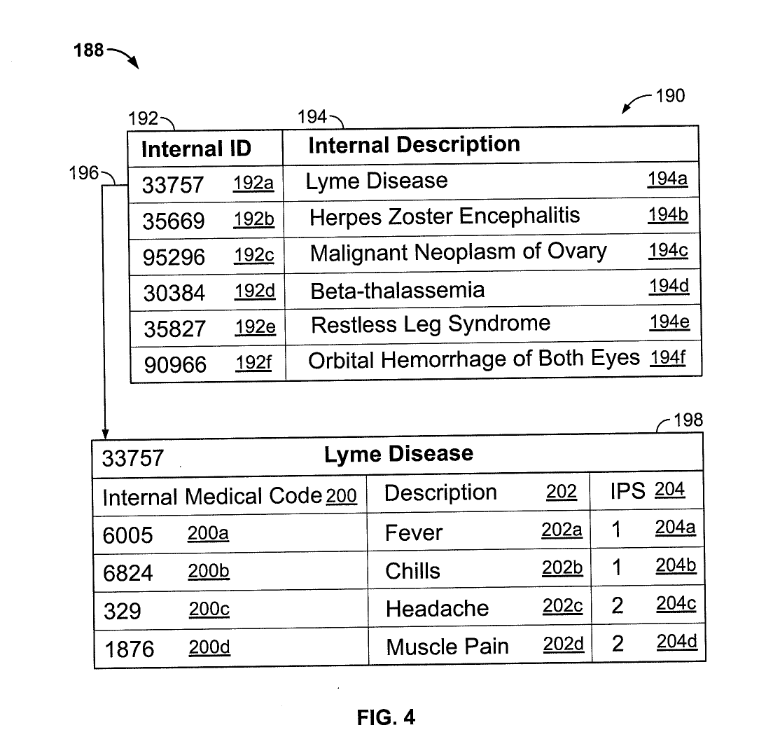

FIG. 4 illustrates an exemplary embodiment of a mapping 188 between an internal medical terminology table 190 in the internal medical terminology 184 to a table 198 in the internal diagnostic relationship data 186. The table 190 includes an internal medical code column 192 and an internal description column 194. The internal medical code column 192 includes internal medical codes 192a-f. The internal description column 194 includes internal descriptions 194a-f. The list 190 is connected to the table 198 through a link 196. The data structure 198 includes an internal medical code column 200, an internal description column 202, and an intelligent prompting score (“IPS”) column 204. The internal medical code column 200 includes internal medical codes 200a-d. The internal description column 202 includes internal descriptions 202a-d. The IPS column 204 includes IPSs 204a-d. Though the tables 190 and 198 appear as tables, it is understood that the internal medical terminology 184 and the internal diagnostic relationship data 186 may organize information in any data structure form.

As illustrated in the table 190, each internal description 194a-f is associated with a corresponding internal medical code 192a-f. The internal medical codes 192a-f are utilized by the internal terminology prompting engine 176 to determine relationships between medical conditions and symptoms and prompt the caregiver when more information is needed by the system 102. For example, if the caregiver inputs “Lyme disease” into the system 102, the internal terminology prompting engine 176 may search the internal diagnostic relationship data 186 for the link 196 to locate table 198 which includes the various symptoms associated with Lyme disease.

As shown, the symptoms in the table 198 also include internal medical codes 200a-d, descriptions 202a-d, and IPSs 204a-d. The IPSs 204a-d indicate the prevalence of the associated symptom with the underlying condition, in this case, Lyme disease. In some embodiments, as FIG. 4 shows, a lower IPS indicates a greater likelihood that the corresponding symptom will be present if the patient is in fact suffering from Lyme disease. Thus, as illustrated, fever and chills are more likely to be associated with a diagnosis of Lyme disease than headache and muscle pain.

The internal medical codes 192a-f and 200a-d are also utilized by the internal-to-external prompting engine 174 to navigate through the internal-to-external relationship data 182 to determine relationships between internal medical codes and external medical codes and prompt the caregiver when more information is needed by the system 102. Such mapping is described in greater detail below.

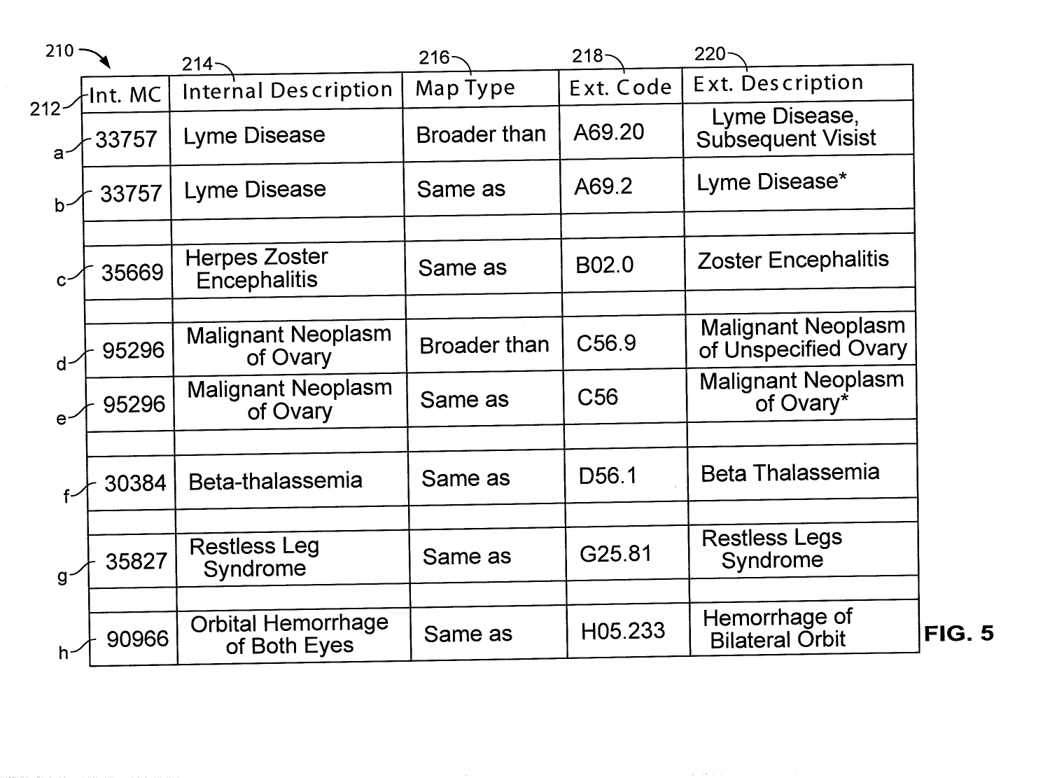

FIG. 5 illustrates an exemplary embodiment of a data structure 210 in the internal-to-external relationship data 182. The data structure 210 includes an internal medical code column 212, an internal description column 214, a map type column 216, an external medical code column 218, and an external description column 220. The internal medical code column 212 includes internal medical codes 212a-h. The internal description column 214 includes internal descriptions 214a-h. The map type column 216 includes map types 216a-h. The external medical code column 218 includes external medical codes 218a-h. The external description column 220 includes external descriptions 220a-h.

The data structure 210 illustrates one example of a mapping between internal medical terminology 184 and external standard terminology 180. For example, as shown in the data structure 210, various internal medical codes 212a-h and the associated internal descriptions 214a-h are mapped to corresponding external codes 218a-h and the associated external descriptions 220a-h.

The map type column 216 indicates the complexity of the mapping between the internal medical codes 212a-h and the external medical codes 218a-h. For example, in some embodiments, the map type may indicate that the internal description is the “same as” the external description, such as the map types 216c, f-h. In these cases, the internal-to-external prompting engine 174 determines that the mapping is one-to-one, and therefore, no further information is needed by the caregiver for the system 102 to determine the corresponding external code.

However, if an internal description has a map type that indicates that the internal description is both “same as” and “broader than” the external description, such as the internal descriptions 214a, b, d, e indicating “Lyme disease” and “malignant neoplasm of ovary”, the internal-to-external prompting engine 174 determines that the mapping is not one-to-one, and therefore, more information is required by the caregiver so that the internal-to-external prompting engine 174 may access the relevant data from the internal-to-external relationship data 182. This is because the map type “broader than” indicates to the system 102 that the internal description associated with the internal code does not exactly correlate with an external description associated with any external code. For example, the closest external description to the internal description may include narrowing aspects to the internal description or may include diagnostically irrelevant information which also narrows the internal description.

For instance, if the caregiver selects “Lyme disease,” the internal-to-external prompting engine 174 might prompt the caregiver for information relating to whether this is a subsequent visit with the patient. In the example, “subsequent visit” is an example of narrowing diagnostically irrelevant information that is present in the external description, but not in the internal description. If the caregiver indicates that it is not a subsequent visit with the patient, the system 102 will select the external code 218b, “A69.2.” However, if the caregiver confirms that it is a subsequent visit with the patient, the system 102 will select the external code 218a, “A69.20.”

In other embodiments, the internal-to-external prompting engine 174 may utilize the response provided by the caregiver to locate and read an expansion table, described in more detail herein, within the hierarchical structures of the internal-to-external relationship data 182 to determine whether more questions need to be prompted to the caregiver to determine the associated external code. The number of hierarchical tables in the internal-to-external relationship data 182 associated with one internal code may indicate how many questions must be prompted to the caregiver to determine the associated external code.

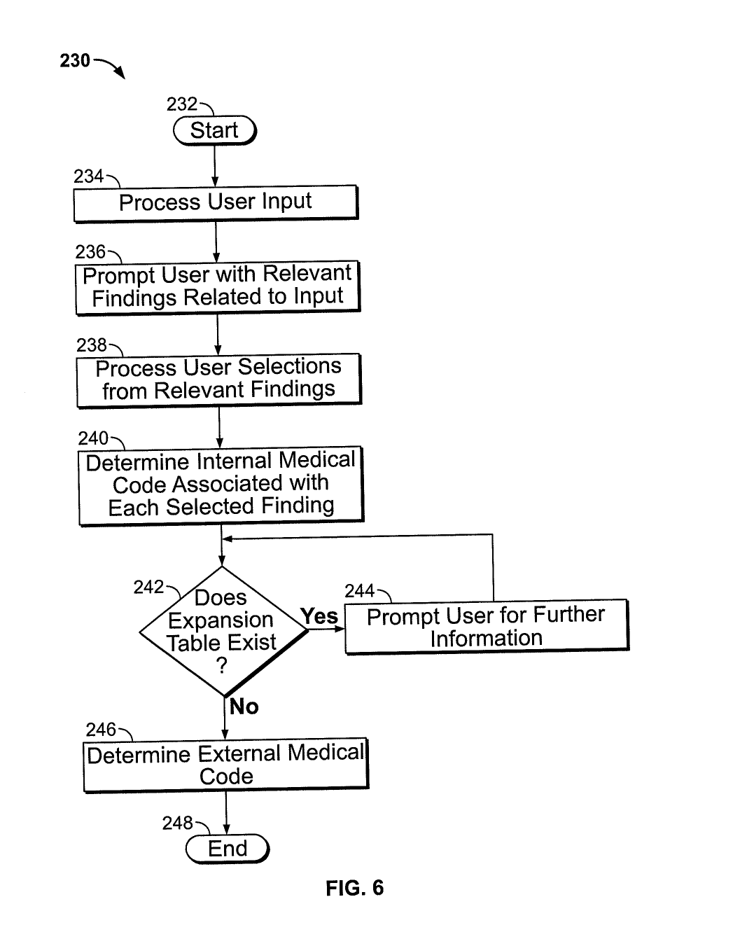

FIG. 6 is a flowchart illustrating an exemplary method 230 of mapping user inputs associated with an internal code to an external code through the medical information coding system 102. The method includes operations 232, 234, 236, 238, 240, 242, 244, 246, and 248 As stated below, a user may be a caregiver who is examining or has examined a patient and is now using the system 102 to document the patient visit.

The method begins with the operation 232. During operation 232, the user of the medical information coding system 102 begins the system and enters initial inputs, such as a medical condition. The user selects or enters, for example, “Lyme disease.” At this time, the system processes the user inputs at the operation 234. In some embodiments, during operation 234, the internal terminology prompting engine 176 accesses the knowledge base 178 to determine the associated internal medical terminology 184 that relates to the user inputs. In some embodiments the input is a data item which is a medical finding that identifies a physical or mental characteristic of a person, such as the patient or a relative of the patient. In other embodiments, the input is a medical finding, as described herein.

At operation 236, the system prompts the user with relevant findings associated with the initial user input. For example, in some embodiments, the internal terminology prompting engine 176 may scan the internal medical terminology 184 and follow any links which exist to the internal diagnostic relationship data 186 to compile all of the associated symptoms with the user-inputted medical condition. After determining the associated symptoms, the internal terminology prompting engine 176 utilizes the user interface engine 170 to prompt the symptoms to the user. Upon prompting the findings to the user, the user is free to select any findings that appear relevant to the patient's condition.

At operation 238, the system 102 processes the findings that the user selected. For example, in some embodiments, the internal terminology prompting engine 176 may search the knowledge base 178 to determine locate the data structures in the internal medical terminology 184 and the internal diagnostic relationship data 186 which relate to the selected findings. At operation 240, the system 102 determines the internal medical codes associated with each selected finding and underlying medical condition. To do this, in some embodiments, the internal terminology prompting engine 176 scans the related data structures gathered during operation 238 and selects the associated internal medical codes with each selected finding and underlying condition. For instance, in the example above, the system 102 would determine the internal medical codes for all of the symptoms of Lyme disease selected by the user, as well as the internal medical code for Lyme disease itself.

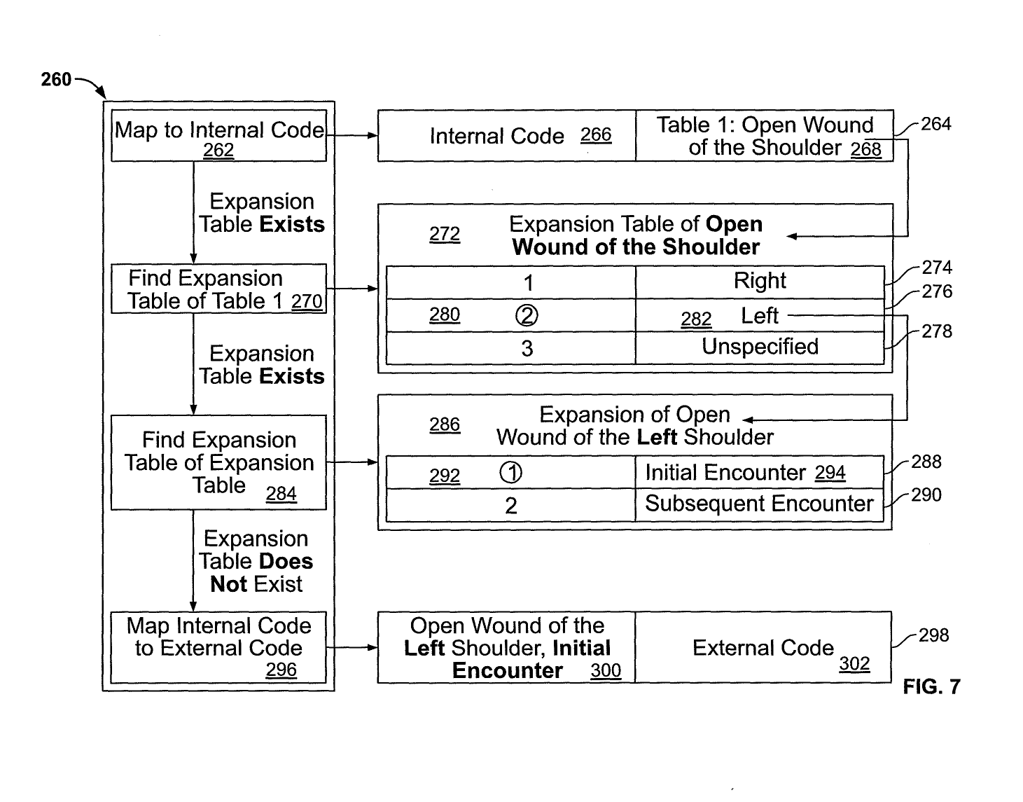

At operation 242, the system 102 makes a determination of whether an expansion table exists for the first internal medical code. As explained above, an expansion table indicates that more information needs to be provided by the user to determine the corresponding external code. In some embodiments, the expansion table can be any data structure which stores information linking the internal medical terminology 184 with the external standard terminology 180. One example of the structure of an expansion table is shown in FIG. 7.

In some embodiments, the determination of whether an expansion table exists is made by the internal-to-external prompting engine 174. The internal-to-external prompting engine 174 uses the internal medical code determined in operation 240 to search the internal-to-external relationship data 182 for this internal medical code. At this time, if the map type associated with the internal medical code indicates that the mapping is not one-to-one (as discussed above in relation to FIG. 5), the internal-to-external prompting engine 174 determines that an expansion table exists. If on the other hand, the map type associated with the internal medical code indicates that the mapping is one-to-one, the internal-to-external prompting engine 174 determines that no expansion table exists.

If it is determined that no expansion table exists, the method proceeds to operation 246 where the external code is determined. In some embodiments, this is accomplished when the internal-to-external prompting engine 174 scans the data structure and retrieves the associated external code. In some embodiments, the external code is displayed to the user by way of the user interface engine 170. In other embodiments, the external code is not displayed to the user, but simply used within the system 102. After retrieving the external code, the method terminates at the end operation 248.

If, on the other hand, the internal-to-external prompting engine 174 determines that an expansion table exists, the user is prompted for further information at operation 244. To determine the question, the internal-to-external prompting engine 174 follows a link in the internal-to-external relationship data 182 to the expansion table and determines the information needed to make a selection in the expansion table. This information is then presented to the user through the user interface engine 170 as either an open-ended question or multiple-choice question or selection. Upon receiving a user response, the method returns to operation 242 and determines if a further expansion table exists. This process is repeated until the internal-to-external prompting engine 174 determines that no further expansion tables exist and an external code can be determined at operation 246. At this time, the method terminates at the end operation 248.

FIG. 7 is a diagram 260 illustrating examples of operations 240-246 of the method 230 (discussed in FIG. 6). The diagram 260 includes operations 262, 270, 284, and 296. The operation 262 utilizes an exemplary internal medical terminology table 264. The operation 270 utilizes an exemplary expansion table 272. The operation 284 utilizes a second exemplary expansion table 286. The operation 296 utilizes an exemplary external standard terminology table 298. The exemplary internal medical terminology table 264 includes an internal code 266 and an internal description 268. The exemplary expansion table 272 includes rows 274, 276, and 278. Row 276 includes an identifier 280 and an expansion table description 282. The second exemplary expansion table 285 includes rows 288 and 290. Row 288 includes an identifier 292 and an expansion table description 294. The exemplary external standard terminology table 298 includes an external description 300 and an external medical code 302.

In operation 262, the system 102 maps the internal description 268 to the internal code 266. In some embodiments, after retrieving the internal code 266, the internal-to-external prompting engine 174 determines whether an expansion table exists by determining whether a map type (not shown) within the internal-to-external relationship data 182 indicates whether the mapping is one-to-one or more complex. In the example embodiment, an expansion table exists for the description, “open wound of the shoulder”, and therefore, at operation 270, the system 102 searches and retrieves the exemplary expansion table 272.

Upon retrieving the expansion table 272, the system 102 determines whether any further information is required by the user. In some embodiments, the internal-to-external prompting engine 174 scans the expansion table and queries the user to choose within the various expansion table descriptions, such as the description 282. In this case, the internal-to-external prompting engine 174 may ask the user to select between: right, left, and unspecified.

If, in the example embodiment, the user selects “left,” the system 102 next determines in operation 284 whether a further expansion table exists for the description, “open wound of the left shoulder.” Again, the internal-to-external prompting engine 174 determines whether an expansion table exists for this description by determining whether a map type (not shown) within the internal-to-external relationship data 182 indicates whether the mapping is one-to-one or more complex. In the example embodiment, an expansion table exists for the description, “open wound of the left shoulder”, and therefore, at operation 284, the system 102 searches and retrieves the second exemplary expansion table 286.

After retrieving the second expansion table 286, the system 102 again determines whether any further information is required by the user to determine an external code for the description. The internal-to-external prompting engine 174 scans the expansion table and queries the user to choose within the various second expansion table descriptions. For example, the system 102 may prompt the user to select between: initial encounter and subsequent encounter.

If, in the example embodiment, the user selection “initial encounter,” the system 102 again determines whether a further expansion table exists for the description. If, in the example embodiment, the system 102 determines that no further expansion table exists, the system 102 then does a one-to-one mapping of the description 300 to the external code 302. In some embodiments, this is accomplished by the internal-to-external prompting engine 174. Upon determining that no expansion table exists, the internal-to-external prompting engine 174 searches the external standard terminology 180 for the description, “open wound of the left shoulder initial encounter,” and retrieves the corresponding external code 302.

In some embodiments, the external code 302 may be formulated by identifiers 280 and 292. For example, if the general external code for “open wound of the shoulder” is “R27,” then the external code 302 may be “R27.21” by utilizing the identifier 280 as the first decimal, indicating the identifier in the first expansion table 272, and utilizing the identifier 292 as the second decimal, indicating the identifier in the second expansion table 292. In other embodiments, however, the identifiers are not utilized in determining the external code 302.

FIG. 8 is an exemplary screen shot 310 from the computing device 112 during use of the system 102. Specifically, the screen shot 310 is an example of an intelligent prompt presented by the intelligent prompting engine 172. The screen shot 310 includes prompt selection rows 312, 314, 316, and user interface buttons 318, 320.

As shown, the screen shot 310 includes three prompt selection rows 312, 314, 316. The user may utilize a pointer input device, a touch sensor, such as a finger or stylus, or any other display selection/input device to select one option from each row 312, 314, 316 so that the system 102 may map the internal code to an external code. It is understood that though in the example embodiment three questions (in selection format) are presented to the caregiver at a single time, other intelligent prompts may be presented to the caregiver as single questions. In some embodiments, this is due to the fact that an answer to one question is dependent on the next question to be answered. However, in other embodiments, as the example embodiment, subsequent questions may not be dependent on the answer of a previous question. Upon selecting an item from each row 312, 314, 316, the caregiver can either submit his responses by selecting the user interface button 318 or cancel his responses by selecting the user interface button 320. In some embodiments, the selection rows 312, 314, and 316 may be compiled into one selection row. The single selection row may include all possible combinations of selections. For example, in the example embodiment, the single selection row may include “Unspecified open wound, Right, Initial Encounter,” “Unspecified open wound, Left, Initial Encounter,” “Unspecified open wound, Unspecified, Initial Encounter,” and so on until all possible combinations of categories are listed.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of coding an aspect of a patient encounter performed by an electronic computing system, the method comprising:
receiving, at a processing unit, a medical finding identifying medical information related to a patient, the medical finding being input by a user;
identifying, by the processing unit, an internal medical code of an internal medical terminology that relates to the medical finding;
retrieving from memory, by the processing unit, one or more alternative data items from an expansion table associated with the internal medical code, the alternative data items defining the medical finding input by the user with great specificity;
generating a graphical user interface, the graphical user interface displaying the medical finding input by the user and the one or more alternative data items, the displayed one or more alternative data items being selectable by the user; and
in response to selecting one of the one or more alternative data items, selecting a code from the standard medical terminology that identifies the medical finding in the standard medical terminology based on the categorical information.

2. The method of claim 1, wherein the standard medical terminology is ICD-10 medical terminology.

3. The method of claim 1, further comprising:
generating a second graphical user interface, the second graphical user interface displaying the code to the caregiver.

4. The method of claim 1, wherein the medical finding is at least one of: a symptom, medical history, an examination finding, a diagnosis, a test, a physical characteristic, a mental characteristic, and a therapy.

5. The method of claim 1, wherein the one or more alternative data items comprises diagnostically relevant information.

6. The method of claim 1, further comprising:
retrieving from memory, by the processing unit, one or more secondary data items from a second expansion table associated with the internal medical code, the secondary data items defining the medical finding input by the user with great specificity;
generating a graphical user interface, the graphical user interface displaying the medical finding input by the user and the one or more secondary data items, the displayed one or more secondary data items being selectable by the use

7. The method of claim 6, wherein the one or more secondary data items comprises diagnostically irrelevant information.

8. A system comprising:
a database encoded on a memory device, the data comprising a first terminology and a second terminology;
the first terminology including a first set of terms identifying medical information, wherein each term of the first set of terms is associated with a first medical code;
the second terminology including a second set of terms, wherein each term of the second set of terms is associated with a second medical code;
a computing device in data communication with the database, wherein the computing device is programmed to retrieve data from the first terminology and map the data to a second medical code.

9. The system of claim 8, further comprising a look-up table having a plurality of columns, wherein each column of the look-up table includes a first term in the first set of terms, and a second term in the second set of terms, and a map type, wherein the map type indicates the complexity of a mapping between the first term and the second term.

10. The system of claim 8, wherein the computing device is configured to:
receive a medical finding identifying medical information related to a patient, the medical finding being input by a user;
identify an internal medical code of the first terminology that relates to the medical finding;
retrieve from memory one or more alternative data items from an expansion table associated with the internal medical code, the alternative data items defining the medical finding input by the user with great specificity;
generate a graphical user interface, the graphical user interface displaying the medical finding input by the user and the one or more alternative data items, the displayed one or more alternative data items being selectable by the user; and
in response to selecting one of the one or more alternative data items, selecting a code from the second terminology that identifies the medical finding in the second terminology based on the categorical information.

11. The system of claim 10, wherein the computing device is a touch screen device configured to enable the caregiver to supply the one or more alternative data items touching the touch screen device.

12. The system of claim 10, wherein the computing device is further configured to:
generate a second graphical user interface, the second graphical user interface displaying the medical finding input by the user and one or more secondary data items, the displayed one or more secondary data items being selectable by the user.

13. The system of claim 10, wherein the second terminology is ICD-10 medical terminology.

14. A computer-readable storage medium comprising instructions that, when executed by a processing unit of an electronic computing system, cause the processing unit to:
receive, at the processing unit, a medical finding identifying medical information related to a patient, the medical finding being input by a user;
identify, by the processing unit, an internal medical code of an internal medical terminology that relates to the medical finding;
retrieve from memory, by the processing unit, one or more alternative data items from an expansion table associated with the internal medical code, the alternative data items defining the medical finding input by the user with great specificity;
generate a graphical user interface, the graphical user interface displaying the medical finding input by the user and the one or more alternative data items, the displayed one or more alternative data items being selectable by the user; and
in response to selecting one of the one or more alternative data items, select a code from the standard medical terminology that identifies the medical finding in the standard medical terminology based on the categorical information.

15. The computer-readable storage medium of claim 14, wherein the medical finding is one of the group consisting of: a symptom, medical history, an examination finding, a diagnosis, a test, a physical characteristic, a mental characteristic, and a therapy.

16. The computer-readable storage medium of claim 14, wherein when the instructions are executed by the processing unit of the electronic computing system, the instructions further cause the processing unit to: generate a second graphical user interface, the second graphical user interface displayed the second medical code and the medical finding to the user.
